(19) United States
(12) Patent Application Publication
(10) Pub. No.: US 2025/0381481 A1
(43) Pub. Date: Dec. 18, 2025

(54) GAME INTERFACE CLASSIFICATION USING ML AND DRIVER OPTIMIZATION

(71) Applicant: ATI Technologies ULC, Markham (CA)

(72) Inventors: Wei Liang, Markham (CA); Shanmukha Sai Vignesh Edithal, Toronto (CA); Le Zhang, Thornhill (CA); Ilia Blank, Concord (CA)

(21) Appl. No.: 18/745,763

(22) Filed: Jun. 17, 2024

(51) Int. Cl. A63F 13/533; A63F 13/52; G06T 11/00; G06V 20/40; G06V 30/19

(52) U.S. Cl. CPC A63F 13/533; A63F 13/52; G06T 11/00; G06V 20/40; G06V 30/19173; G06T 2210/52

(57) ABSTRACT

An apparatus and method for performing efficient video data processing. In various implementations, a computing system includes a client device executing a parallel data graphics application that processes multiple video frames. The application includes multiple iterations of a loop with each loop processing a single video frame such as rendering and presenting the rendered video frame to a display controller. The client device adjusts the rendering operation and the presenting operation for subsequent video frames based on an image type of the current video frame. The client device utilizes an image classification data model that relies on machine learning techniques to generate an indication specifying the category (image type) of multiple categories of the current video frame based on the rendered data of the video frame. Examples of the categories are a menu image, an application loading image, a scoreboard image, and an active gameplay image.

### BACKGROUND

### Description of the Relevant Art

Video processing algorithms are complex and include many different functions. Advanced processors are used to satisfy the high computation demands. The video processing complexity increases as display resolution increases. Additionally, high definition video encoding applications are growing rapidly in the consumer market space. Further, video processing becomes more complex as the available data bandwidth decreases and the processing occurs in real-time. For example, virtual reality (VR) applications, such as VR gaming applications, are becoming more popular. Additionally, desktop streaming services have become commonplace and include services that allows a user to access in real-time through a network, such as the Internet, a variety of content provided on remote servers. Video game (or gaming) streaming services is an example of services providing real-time presentation of content on a user's remote computing device where the content is updated in real-time based on user input.

The client device includes a parallel data processing circuit, such as graphics processing unit (GPU) or other, in addition to a graphics driver that performs video processing steps for the video game application. Whether the video game application is provided from remote servers or from a local hard drive, the user's client device is unaware of what stage the video game application is at for processing. For example, the video game application can be presenting a menu on the screen, or currently receiving inputs from the user during active gameplaying or performing a load operation of files of the application, or other. Without knowledge of the current stage, selection and use of settings and operating parameters by the parallel data processing circuit and the graphics driver is not based on the current stage of the video game application. Mismatches between the settings and the stage of the video game application can lead to at least higher power consumption without performance benefit and visual artifacts on the screen of the display device.

In view of the above, methods and systems for performing efficient video data processing are desired.

### BRIEF DESCRIPTION OF THE DRAWINGS

FIG. 1 is a generalized diagram of a screen of a display device of a client device that performs efficient video data processing.

FIG. 2 is a generalized diagram of a computing system that performs efficient video data processing.

FIG. 3 is a generalized diagram of a method for efficiently performing efficient video data processing.

FIG. 4 is a generalized diagram of a screen of a display device of a client device that performs efficient video data processing.

FIG. 5 is a generalized diagram of a method for efficiently performing efficient video data processing.

FIG. 6 is a generalized diagram of an apparatus that performs efficient video data processing.

FIG. 7 is a generalized diagram of a screen of a display device of a client device that performs efficient video data processing.

FIG. 8 is a generalized diagram of a method for efficiently performing efficient video data processing.

FIG. 9 is a generalized diagram of a screen of a display device of a client device that performs efficient video data processing.

FIG. 10 is a generalized diagram of a method for efficiently performing efficient video data processing.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for performing efficient video data processing are contemplated. In various implementations, a computing system includes a client device with a display device for presenting images on a screen. The client device executes a parallel data graphics application that processes multiple video frames. In various implementations, the parallel data graphics application (or application) is a video game application. The application includes multiple iterations of a loop with each loop processing a single video frame. The processing of the video frame includes at least rendering the video frame and presenting the rendered video frame by sending the rendered video frame to a display controller connected to the display device. The client device adjusts one or more of the rendering operation and the presenting operation for subsequent video frames based on an image type of the current video frame. The client device utilizes an image classification data model to generate an indication specifying the image type of the current video frame. The generated indication is based on the rendered output data of the current video frame. In various implementations, the image classification data model is a trained neural network used to perform machine learning for generation of the indication specifying the image type of the current video frame.

When the client device has completed rendering the current video frame, the graphics driver or another component of the client device sends the rendered video frame to the image classification data model. The graphics driver or other component of the client device receives, from the image classification data model, an indication specifying a category of multiple categories corresponding to the image type of the rendered video frame to be presented on the display device. Examples of the categories are a menu image, an application loading image, a scoreboard image, and an active gameplay image.

By using the image classification data model, the client device avoids interacting with the application to discover the category (image type) of the rendered video frame. The client device does not access any files of the application or use an application programming interface (API) to access information or run a particular process to generate information. Applications from different vendors would provide different methods for accessing requested information, which causes the graphics driver or other component of the client device to support multiple formats and require updates over time. In addition, the client device avoids object recognition tools and text recognition tools that would provide intermediate results to yet another tool to generate the indication specifying the category (image type) of the rendered video frame. Such an approach has a large latency and consumes many computing resources of the client device.

In some implementations, the client device is connected to one or more remote servers via a network such as the Internet. In an implementation, the application is a streaming video game application. Examples of the client device are a laptop computer, a smartphone, a gaming console connected to a television, a tablet computer, a desktop computer, or otherwise. The client device includes a parallel data processing circuit utilizing a parallel data microarchitecture to process video frames. Examples of the parallel data processing circuit are a graphics processing unit (GPU), a digital signal processing circuit (DSP), a field programmable gate arrays (FPGA), an application specific integrated circuit (ASIC), and so forth. The parallel data processing circuit executes instructions of the graphics driver.

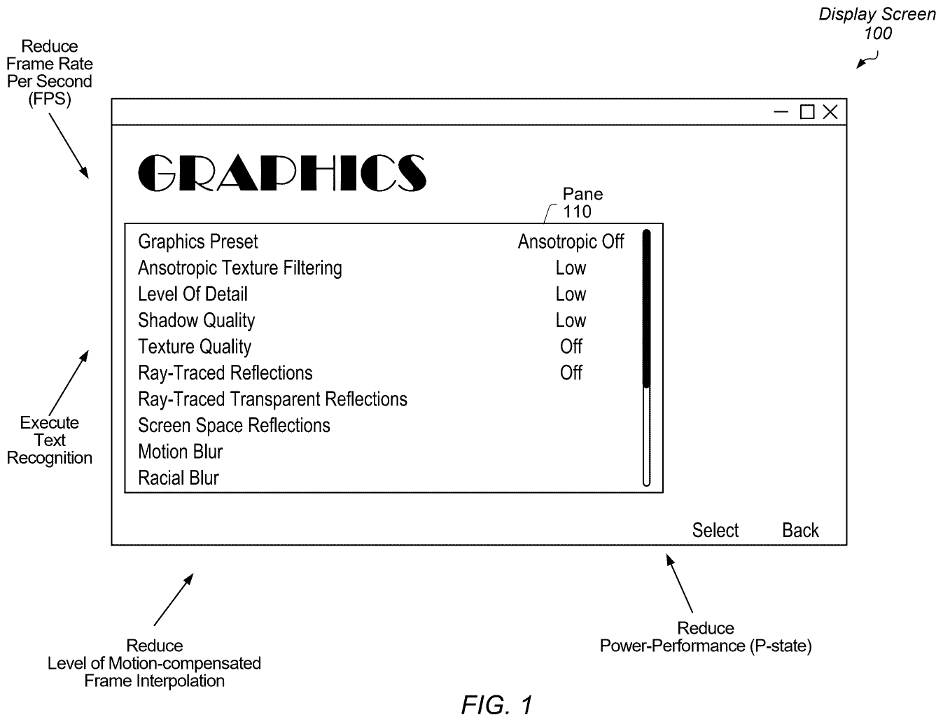

In an implementation, when the parallel data processing circuit receives the indication specifying the category of the rendered video frame, the parallel data processing circuit sends commands, based on the category, that adjust one or more operation parameters. The one or more operating parameters being adjusted include a rate of processing video frames, such as a frames per second (FPS) parameter, indications specifying the performance level of graphics tasks and non-graphics tasks, a level of motion-compensated frame interpolation, and identifiers specifying subregions of the video frame using different levels of rending compared to other regions of the video frame. Further details of these techniques to perform efficient video data processing are provided in the following description of FIGS. 1-10.

Turning now to FIG. 1, a generalized diagram is shown of a display screen 100 of a computing device that performs efficient video data processing. In various implementations, display screen 100 is a menu image of a video game application presented on a display device of a user's computing device. Other components of the display device are not shown for ease of illustration. The menu image provides an example of an image that corresponds to a rendered video frame of a parallel data graphics application such as a video game application. A parallel data processing circuit rendered the video frame and sent the rendered video frame to a display controller of a display device of a client device. Examples of the parallel data processing circuit are a graphics processing unit (GPU), a digital signal processing circuit (DSP), a field programmable gate arrays (FPGA), an application specific integrated circuit (ASIC), and so forth. Examples of the client device are a laptop computer, a smartphone, a gaming console connected to a television, a tablet computer, a desktop computer, or otherwise.

Display screen 100 includes text of varying font and size such as “Graphics” outside of pane 110 and text within pane 100 that includes menu options such as “Graphics Preset,” “Ansotropic Texture Filtering,” and so on. The menu image includes a Select button for selecting one of the menu options shown on the menu image and a Back button to return to a previous menu of another menu image. In other implementations, the menu image includes other types of buttons, drop-down menus, and so on that either show information in another manner (e.g., a pie chart, a three-dimensional figure, etc.) or provide other types of functionalities.

In addition to sending the rendered video frame to the display controller, in various implementations, the parallel data processing circuit sends the rendered video frame to an image classification data model. In various implementations, the image classification data model is a trained neural network used to perform machine learning for generation of the indication specifying the image type of the current video frame. The image classification data model uses a machine learning techniques that rely on one of a recurrent neural network (RNN) structure, a convolutional neural network (CNN) structure, a deep neural network (DNN) structure, a feed-forward neural network with one hidden layer, a combination of a vision transformer (ViT) and a transformer encoder that receives vector embeddings from the ViT, and so forth.

In some implementations, training of the image classification data model includes sending, to the image classification data model, an input dataset of known categories (image types) corresponding to rendered video frames. Examples of the categories are a menu image, an application loading image, a scoreboard image, an active gameplay image, and so on. The rendered video frames corresponding to these categories are from multiple parallel data graphics applications such as video game applications. After training completes, the trained image classification data model is used to provide inference based on rendered video frames from the framebuffer. The trained image classification data model is not dependent on any one of the multiple parallel data graphics applications such as video game applications. For a received rendered video frame from the framebuffer, the image classification data model provides one or more scores indicating the category (image type) of multiple categories corresponding to the rendered video frame. The executed by the parallel data processing circuit, the graphics driver selects the category with the highest score such as one of a menu image, an application loading image, a scoreboard image, and an active gameplay image, and so on.

The parallel data processing circuit sends commands, based on the category, to components of the client device to adjust one or more of the rendering and presenting operations for subsequent video frames. In various implementations, the commands adjust one or more operation parameters such as a rate of processing video frames, such as a frames per second (FPS) parameter. The one or more operating parameters being adjusted also include indications specifying the performance level of graphics tasks and non-graphics tasks, a level of motion-compensated frame interpolation, and identifiers specifying subregions of the video frame using different levels of rending compared to other regions of the video frame. As shown by notations, for the menu image, the parallel data processing circuit generates commands to reduce the FPS parameter, reduce the level of motion-compensated frame interpolation, reduce the performance and power consumption of at least the parallel data processing circuit, and send the rendered video frame to a text recognition tool.

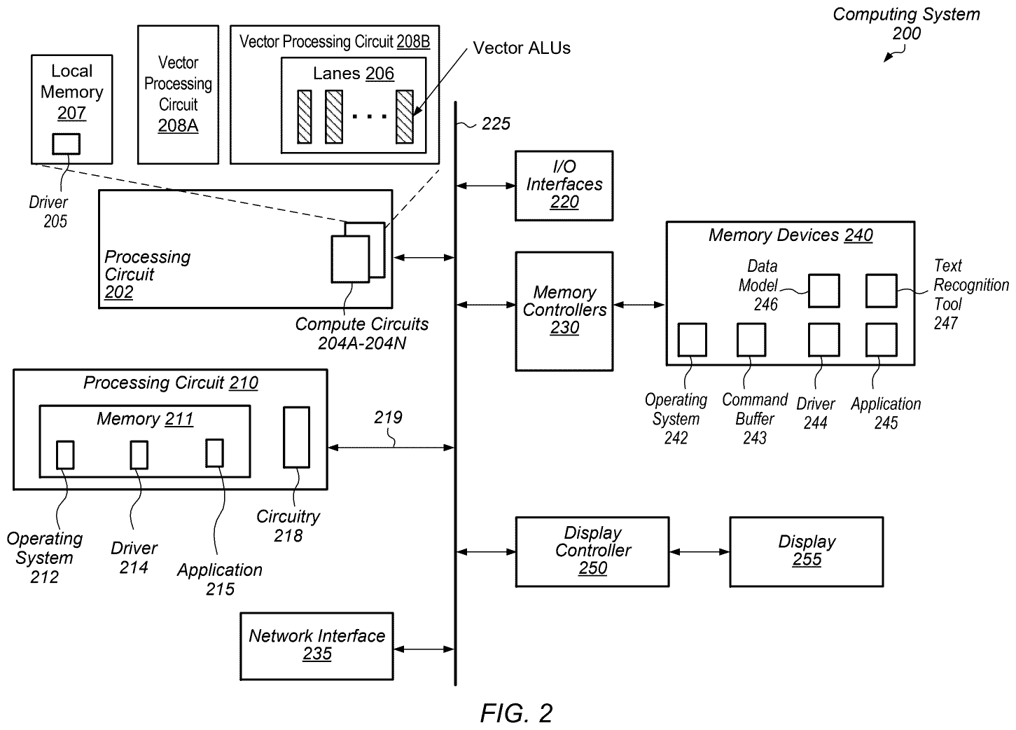

In some implementations, the text recognition tool is another data model that performs text recognition such as optical character recognition (OCR). The text recognition tool identifies options, items, characteristics, lists and so forth presented on the image corresponding to the rendered video frame. Based on result data from the text recognition tool, the corresponding client device provides data to the display controller specifying an overlay window to place on the screen with suggestions or information for the user. These and other adjustments are further described in the description of FIGS. 2-11.

Turning now to FIG. 2, a generalized diagram is shown of a computing system 200 that efficiently accesses hardware resources in a virtualized environment. In an implementation, computing system 200 includes at least processing circuits 202 and 210, input/output (I/O) interfaces 220, bus 225, network interface 235, memory controllers 230, memory devices 240, display controller 250, and display device 255. In other implementations, computing system 200 includes other components and/or computing system 200 is arranged differently. For example, power management circuitry, and phased locked loops (PLLs) or other clock generating circuitry are not shown for ease of illustration. In various implementations, the components of the computing system 200 are on the same die such as a system-on-a-chip (SOC). In other implementations, the components are individual dies in a system-in-package (SiP) or a multi-chip module (MCM). A variety of computing devices use the computing system 200 such as a desktop computer, a laptop computer, a server computer, a tablet computer, a smartphone, a gaming device, a smartwatch, and so on.

Processing circuits 202 and 210 are representative of any number of processing circuits which are included in computing system 200. In an implementation, processing circuit 210 is a general-purpose processing circuit, such as a central processing unit (CPU) and circuitry 218 includes multiple general-purpose processor cores, each with one or more general-purpose pipelines that execute instructions of a particular instruction set architecture (ISA). Memory 211 represents a local hierarchical cache memory subsystem of processing circuit 210. Memory 211 stores source data, intermediate results data, results data, and copies of data and instructions stored in memory devices 240. Examples are the operating system 212 (copy of at least a portion of operating system 242), driver 214 (copy of at least a portion of driver 244), and application 215 (copy of at least a portion of application 245).

Processing circuit 210 is coupled to bus 225 via interface 219. In an implementation, interface 219 uses the communication protocol of a peripheral component interconnect (PCI) bus, a PCI-Extended (PCI-X), or a PCIE (PCI Express) bus. In some implementations, processing circuit 210 has a direct point-to-point (P2P) connection with processing circuit 202 that bypasses bus 225. Processing circuit 210 receives, via interface 219, copies of various data and instructions, such as a host operating system 212, one or more device drivers, such as driver 214, one or more applications such as application 215, and/or other data and instructions.

In one implementation, processing circuit 202 is a parallel data processing circuit with a highly parallel data microarchitecture. Examples of processing circuit 202 are a graphics processing unit (GPU), a digital signal processing circuit (DSP), a field programmable gate arrays (FPGA), an application specific integrated circuit (ASIC), and so forth. Processing circuit 202 executes instructions of a graphics driver such as driver 205. Processing circuit 202 can be a discrete device, such as a dedicated GPU (dGPU), or processing circuit 202 can be integrated in the same package as another processing circuit such as processing circuit 210. In such cases, processing circuit 202 is an integrated GPU (iGPU).

In various implementations, processing circuit 202 includes multiple, replicated compute circuits 204A-204N, each including similar circuitry and components such as the vector processing circuits 208A-208B, local memory 207, and other hardware resources (not shown) such as fixed-function circuits. Vector processing circuit 208B includes replicated circuitry of the circuitry of vector processing circuit 208A. Although two vector processing circuits are shown, in other implementations, another number of vector processing circuits is used based on design requirements. As shown, vector processing circuit 208B includes multiple, parallel computational lanes 206. Each lane is also referred to as a single instruction multiple data (SIMD) lane. Within a given row across the SIMD lanes, a vector arithmetic logic circuit includes the same circuitry and functionality, and operates on the same instruction, but different data associated with a different thread.

A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner. In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.” Tasks performed by processing circuit 202 can be grouped into a “workgroup” that includes multiple thread groups (or multiple wavefronts). The hardware, such as circuitry, of a command processing circuit (not shown) schedules a workgroup to the vector processing circuits 208A-208B.

In some implementations, application 245 (and its copy 215) is a highly parallel data application that provides multiple kernels to be executed on vector processing circuits 208A-208B. The high parallelism offered by the hardware of vector processing circuits 208A-208B is used for real-time data processing. Examples of real-time data processing are rendering multiple pixels, image blending, pixel shading, vertex shading, and geometry shading. In such cases, each of the data items of a wavefront is a pixel of an image. In an implementation, application 245 (and its copy 215) is a video game application that processes the pixel data of multiple video frames.

A developer writes application 245 in one of a variety of high-level programming languages such as C++ and processing circuit 210 begins processing application 215. When executed by circuitry 218, a graphics library uses the installation of the user mode driver (UMD) of graphics driver package (or driver) 214. Driver 214 is a copy of driver 244. It is noted that depending on the implementation, driver 214 can be implemented using any suitable combination of hardware, software, and/or firmware. Driver 214 translates function calls in application 215 to commands particular to a piece of hardware such as processing circuit 202. When executed by circuitry 218, the UMD sends the translated commands to command buffer 243 in memory devices 240 to be accessed by the installation of kernel mode driver (KMD) of driver 214 via an input/output (I/O) interface of the operation system 212. In one implementation, the I/O control system call interface is used. Processing circuit 202 retrieves the translated commands from command buffer 243 and executes the commands using vector processing circuits 208A-208B.

The processing of a video frame includes at least rendering the pixel data of the video frame using vector processing circuits 208A-208B. Processing circuit 202 presents the rendered video data by sending the rendered video data to display controller 250. In some implementations, a condition to select a rendered video frame is a count of video frames reaching a count threshold. In other implementations, the condition is an amount of elapsed time reaching a duration threshold. When the condition is satisfied, the driver 205 or another component of processing circuit 202 sends the rendered video frame to a copy of data model 246. In some implementations, one or more of processing circuit 210 and processing circuit 202 execute the instructions of the copy of data model 246. In an implementation, data model 246 is a machine learning (ML) data model. Examples of the machine learning data model are one of multiple types of convolutional machine learning data models, deep machine learning data models, and recurrent machine learning data models.

Processing circuit 202 receives, from the copy of data model 246, an indication specifying a category of multiple categories corresponding to the image of the rendered video frame to be presented on display 255. Each of the categories specifies a type of image corresponding to a rendered video frame of application 215 to be presented on display 255. Examples of the categories are a menu image, an application loading image, a scoreboard image, and an active gameplay image. The active gameplay image can include a variety of types of images such as a first person point of view of a flight game or a racing game or a sporting event game or a fantasy and adventure game, a third person point of view of a character in a game environment, a top view of a puzzle or a card game, and so forth. Other examples of the categories are a character or avatar selection image that presents a list of different characters from which to choose by the user, an inventory image that presents a list of objects for the character to carry or wear, a skill image that presents a skill level tree indicating a player's or character's strengths, and a map image that presents a top level view of a playing environment.

Processing circuit 202 sends commands, based on the category, to vector processing circuits 208A-208B and other hardware resources (not shown) to adjust one or more of the rendering and presenting operations for subsequent video frames. In various implementations, the commands adjust one or more operational parameters. Examples of the operational parameters are the rate of processing video frames, such as a frames per second (FPS) parameter, indications specifying the performance level of graphics tasks and non-graphics tasks, a level of motion-compensated frame interpolation, and identifiers specifying subregions of the video frame using different levels of rending compared to other regions of the video frame.

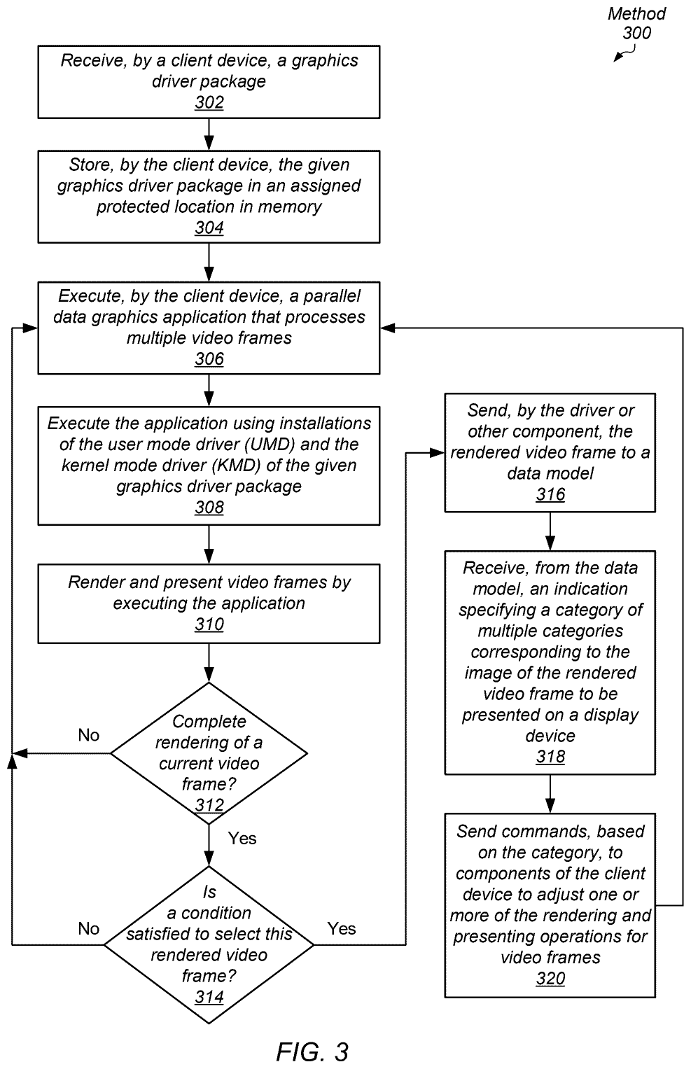

In some implementations, one or more of processing circuits 202 and 210 execute instructions of a copy of text recognition tool 247, which is another data model that performs text recognition such as optical character recognition (OCR). Text recognition tool 247 identifies options, items, characteristics, lists and so forth presented on the image corresponding to the rendered video frame. Based on result data from the text recognition tool 247, one or more of processing circuits 202 and 210 provide data to display controller 250 specifying an overlay window to place on the screen of display 255 with suggestions or information for the user. These and other adjustments are further described in the description of FIGS. 3-11. Before providing the further description, other components of computing system 200 are described here.

In some implementations, computing system 200 utilizes a communication fabric (“fabric”), rather than the bus 225, for transferring requests, responses, and messages between the processing circuits 202 and 210, the I/O interfaces 220, the memory controllers 230, the network interface 235, and the display controller 250. When messages include requests for obtaining targeted data, the circuitry of interfaces within the components of computing system 200 translates target addresses of requested data. In some implementations, the bus 225, or a fabric, includes circuitry for supporting communication, data transmission, network formats, interface signals and synchronous/asynchronous clock domain usage for routing data.

Memory controllers 230 are representative of any number and type of memory controllers accessible by processing circuits 202 and 210. While memory controllers 230 are shown as being separate from processing circuits 202 and 210, it should be understood that this merely represents one possible implementation. In other implementations, one of memory controllers 230 is embedded within one or more of processing circuits 202 and 210 or it is located on the same semiconductor die as one or more of processing circuits 202 and 210. Memory controllers 230 are coupled to any number and type of memory devices 240.

Memory devices 240 are representative of any number and type of memory devices. For example, the type of memory in memory devices 240 includes Dynamic Random Access Memory (DRAM), Static Random Access Memory (SRAM), NAND Flash memory, NOR flash memory, Ferroelectric Random Access Memory (FeRAM), or otherwise. Memory devices 240 store at least instructions of an operating system, one or more device drivers, and application. In some implementations, an application stored on memory devices 240 is a highly parallel data application such as a video graphics application, a shader application, or other. Copies of these instructions can be stored in a memory or cache device local to processing circuit 210 and/or processing circuit 202.

I/O interfaces 220 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 220. Such peripheral devices include (but are not limited to) displays, keyboards, mice, printers, scanners, joysticks or other types of game controllers, media recording devices, external storage devices, and so forth. Network interface 235 receives and sends network messages across a network. In various implementations, driver 214 is a video graphics driver downloaded from a network, such as the Internet, via the network interface 235. The driver 214 is a graphics driver package that includes separate components. The separate components include at least two driver files, an installation file, a catalog file, and device files. The two driver files of the graphics driver package include dynamic link libraries (DLL) files of a user mode driver (UMD) and a kernel mode driver (KMD). The installation file (.inf file) includes information such as a name of the graphics driver package, a version of the graphics driver package, and registry information. The catalog file includes cryptographic hash values of one or more files in the graphics driver package. These hash values are used by operating system 212 to verify that the graphics driver package was not altered after the graphics driver package was published (created). The device files include one or more of a device installation application, a device icon, and device properties.

When executed by circuitry 218, operating system 212 authenticates the graphics driver package. After successful authentication, operating system 212 stores the components of the graphics driver package in a protected system folder. In an implementation, the operating system is a version of the Microsoft® Windows® operating system, and the protected system folder in such a system is called the “Driver Store.” The process of copying the graphics driver package to the protected system folder after authentication is called “staging.”

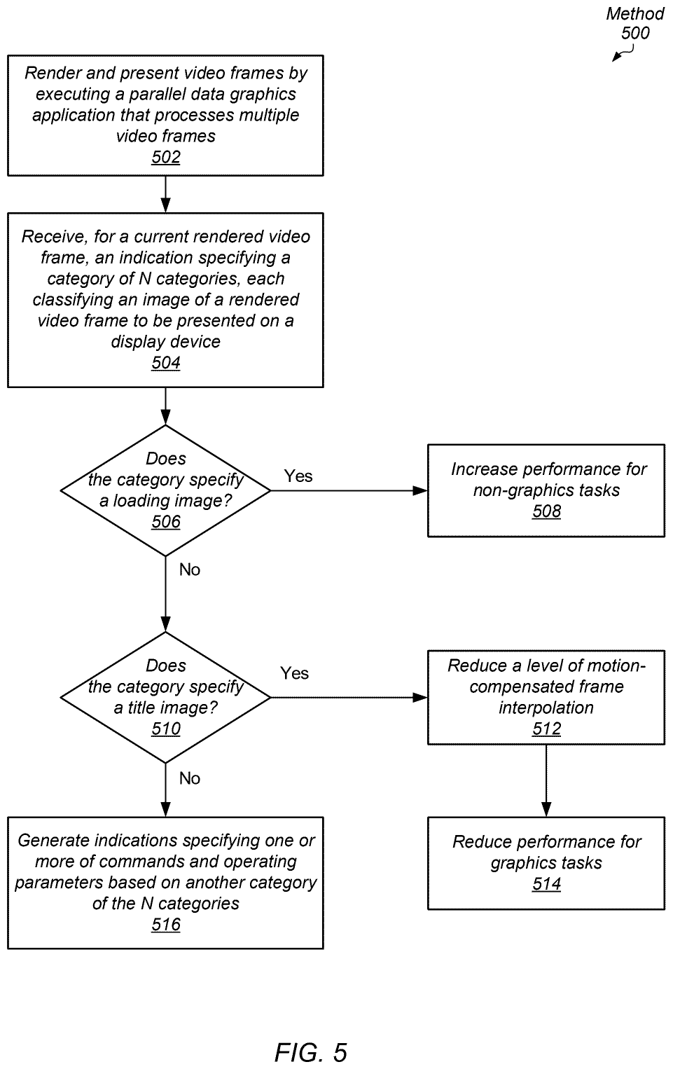

Referring now to FIG. 3, a generalized block diagram is shown of a method 300 for performing efficient video data processing. For purposes of discussion, the steps in this implementation (as well as in FIGS. 5, 8 and 11) are shown in sequential order. However, in other implementations some steps occur in a different order than shown, some steps are performed concurrently, some steps are combined with other steps, and some steps are absent.

In various implementations, a client device includes hardware such as one or more processing circuits. Examples of the client device are a laptop computer, a smartphone, a gaming console connected to a television, a tablet computer, a desktop computer, or otherwise. The client device receives a graphics driver package (block 302). In some implementations, a user requests the graphics driver package, and the client device receives a copy of the graphics driver package that is downloaded from a network such as the Internet. The client device stores the given graphics driver package in an assigned protected location in memory (block 304). In an implementation, the client device receives the downloaded copy of the graphics driver package, and when executed by the circuitry of the client device, the operating system authenticates the graphics driver package. After successful authentication, the operating system stores the components of the graphics driver package in a protected system folder (such as Driver Store). The process of copying the graphics driver package to the protected system folder after authentication is called “staging.”

The client device executes a parallel data graphics application that processes the pixel data of multiple video frames (block 306). In some implementations, the parallel data graphics application is a video game application. The client device executes the parallel data graphics application using installations of the user mode driver (UMD) and the kernel mode driver (KMD) of the given graphics driver package (block 308). A developer writes the parallel data graphics application (or application) in one of a variety of high-level programming languages such as such as C, C++, FORTRAN, Java and so on. A general-purpose processing circuit, such as a CPU or other, of the client device begins processing the application. When executed by the general-purpose processing circuit, a graphics library uses the installation of the user mode driver (UMD) of the graphics driver package to translate function calls in the application to commands particular to a piece of hardware such as a parallel data processing circuit. An example of the parallel data processing circuit is a GPU. When executed by the general-purpose processing circuit, the UMD sends the translated commands to the installation of kernel mode driver (KMD) via an input/output (I/O) interface of the operation system. In one implementation, the I/O control system call interface is used.

The application includes multiple iterations of a loop with each loop processing a single video frame. The processing of the video frame includes at least rendering the video frames using the parallel data processing circuit and presenting the rendered video data by sending the rendered video data to a display controller (block 310). If the parallel data processing circuit has not yet completed rendering the current video frame (“no” branch of the conditional block 312), then control flow of method 300 returns to block 306 where the client device executes a parallel data graphics application that processes multiple frames of video data.

If the parallel data processing circuit has completed rendering the current video frame (“yes” branch of the conditional block 312), but a condition to select this rendered video frame is not satisfied (“no” branch of the conditional block 314), then control flow of method 300 returns to block 306 where the client device executes a parallel data graphics application that processes multiple frames of video data. In some implementations, the condition is a count of video frames reaching a count threshold. In other implementations, the condition is an amount of elapsed time reaching a duration threshold. If the parallel data processing circuit has completed rendering the current video frame (“yes” branch of the conditional block 312), and the condition to select this rendered video frame is satisfied (“yes” branch of the conditional block 314), then the driver or another component of the client device sends the rendered video frame to an image classification data model (block 316). In various implementations, the parallel data processing circuit utilizes an image classification data model to generate an indication specifying the image type (category) of the current video frame. Examples of the categories include at least a menu image, an application loading image, a scoreboard image, and an active gameplay image. The generated indication is based on the rendered output data of the current video frame.

In various implementations, the image classification data model is a trained neural network used to perform machine learning for generation of the indication specifying the image type of the current video frame. The image classification data model uses a machine learning techniques that rely on one of a recurrent neural network (RNN) structure, a convolutional neural network (CNN) structure, a deep neural network (DNN) structure, a feed-forward neural network with one hidden layer, a combination of a vision transformer (ViT) and a transformer encoder that receives vector embeddings from the ViT, and so forth. The image classification data model uses an input layer, one or more hidden layers, and an output layer. Each of these layers has one or more neurons (or nodes). Each of these neurons receives input data from the input layer. In the one or more hidden layers and the output layer, each of the neurons receives input data as output data from one or more neurons of a previous layer. These neurons also receive one or more weight values that are combined with corresponding input data. Typically, the neurons use matrix multiplication, such as General Matrix Multiplication (GEMM) operations, to perform the combining step.

In some implementations, training of the image classification data model includes sending, to the image classification data model, an input dataset of known categories (image types) corresponding to rendered video frames. The rendered video frames corresponding to these categories are from multiple parallel data graphics applications such as video game applications. After training completes, the trained image classification data model is used to provide inference based on rendered video frames from the framebuffer. The trained image classification data model is not dependent on any one of the multiple parallel data graphics applications such as video game applications. In some implementations, when executing the instructions of the driver, firmware, or other dedicated software for adjusting the processing of video frames, the parallel data processing circuit sends the rendered video frame to the image classification data model. In other implementations, the parallel data processing circuit includes dedicated hardware that sends the rendered video frame to the image classification data model when the condition is satisfied to send the rendered video frame to the image classification data model.

The parallel data processing circuit receives, from the image classification data model, an indication specifying a category of multiple categories corresponding to the image of the rendered video frame to be presented on a display device (block 318). Each of the categories specifies a type of image corresponding to a rendered video frame of the parallel data graphics application to be presented on a display device. As described earlier, examples of the categories are a menu image, an application loading image, a scoreboard image, and an active gameplay image. The active gameplay image can include a variety of types of images such as a first person point of view of a flight game or a racing game or a sporting event game or a fantasy and adventure game, a third person point of view of a character in a game environment, a top view of a puzzle or a card game, and so forth. Other examples of the categories are a character or avatar selection image that presents a list of different characters from which to choose by the user, an inventory image that presents a list of objects for the character to carry or wear, a skill image that presents a skill level tree indicating a player's or character's strengths, and a map image that presents a top level view of a playing environment.

The parallel data processing circuit sends commands, based on the category, to components of the client device to adjust one or more of the rendering and presenting operations for subsequent video frames (block 320). In various implementations, the commands adjust one or more operation parameters such as a rate of processing video frames, such as a frames per second (FPS) parameter. The one or more operating parameters being adjusted also include indications specifying the performance level of graphics tasks and non-graphics tasks, a level of motion-compensated frame interpolation, and identifiers specifying subregions of the video frame using different levels of rending compared to other regions of the video frame.

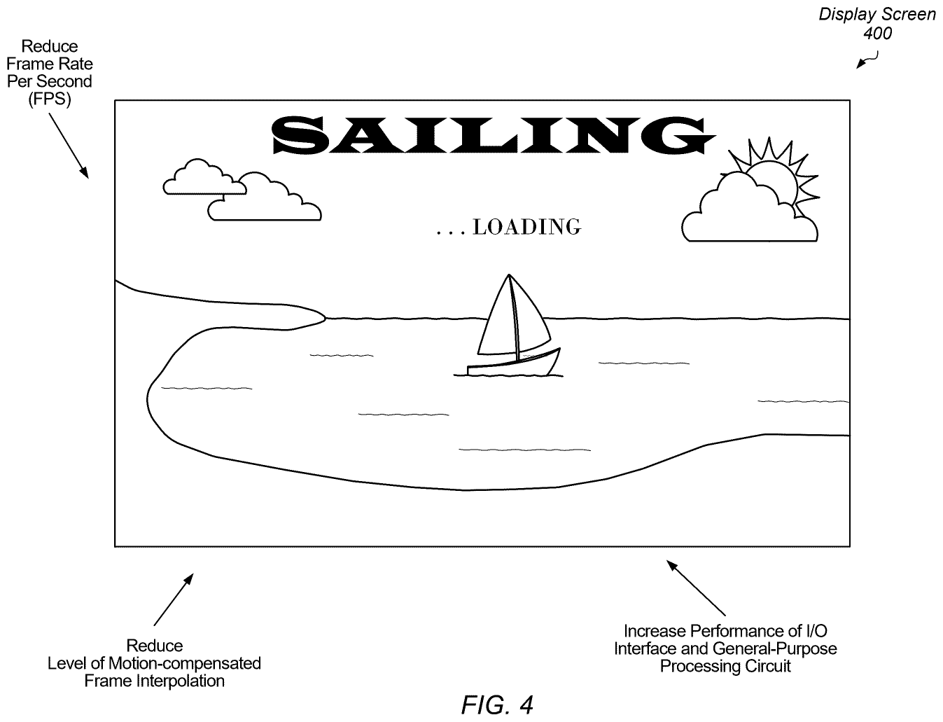

Turning now to FIG. 4, a generalized diagram is shown of a display screen 400 of a computing device that performs efficient video data processing. In various implementations, display screen 400 is a loading image of a video game application presented on a display device of a user's computing device. Other components of the display device are not shown for ease of illustration. The loading image provides an example of an image that corresponds to a rendered video frame of a parallel data graphics application such as a video game application. Display screen 400 includes text of varying font and size such as the title “Sailing” and text of a message “ . . . Loading” to inform the user of the current action of the application.

The parallel data processing circuit of the client device sends commands, based on the category of the loading image, to components of the client device to adjust one or more of the rendering and presenting operations for subsequent video frames. As shown by notations, for the loading image, the parallel data processing circuit generates commands to reduce the FPS parameter, reduce the level of motion-compensated frame interpolation, and increase the performance of an input/output (I/O) interface and a general-purpose processing circuit responsible for performing the steps of loading the parallel data graphics application.

Referring now to FIG. 5, a generalized block diagram is shown of a method 500 for performing efficient video data processing. A parallel data processing circuit of a client device renders and presents video frames by executing a parallel data graphics application that processes multiple video frames (block 502). The parallel data processing circuit (or processing circuit) receives, for a current rendered video frame, an indication specifying a category of N categories, each classifying an image of a rendered video frame to be presented on a display device (block 504). Here, N is a positive, non-zero integer. Each of the categories specifies a type of image corresponding to a rendered video frame of the parallel data graphics application to be presented on a display device. In some implementations, the parallel data graphics application is a video game application. Examples of the categories are a menu image, an application loading image, a scoreboard image, and an active gameplay image. The active gameplay image can include a variety of types of images such as a first person point of view of a flight game or a racing game or a sporting event game or a fantasy and adventure game, a third person point of view of a character in a game environment, a top view of a puzzle or a card game, and so forth. Other examples of the categories are a character or avatar selection image that presents a list of different characters from which to choose by the user, an inventory image that presents a list of objects for the character to carry or wear, a skill image that presents a skill level tree indicating a player's or character's strengths, and a map image that presents a top level view of a playing environment.

If the category specified by the received indication is a loading image (“yes” branch of the conditional block 506), then the client device increases performance for non-graphics tasks (block 508). This reduction and other steps and decisions are used for rendering subsequent video frames until an indication specifying another category is received. In an implementation, the client device provides higher priority levels to input/output (I/O) tasks and general-purpose tasks executed by the I/O interfaces and the general-purpose processing circuit. The client device provides lower priority levels to parallel data tasks executed by the parallel data processing circuit. The client device can also adjust the power-performance states (P-states) of at least the I/O interfaces, general-purpose processing circuit, and parallel data processing circuit to modify one or more of the operating clock frequencies and operating power supply voltages of these components. The client device adjusts the P-states of these components to increase the performance of the of the I/O interfaces and the general-purpose processing circuit, and to reduce the performance of the parallel data processing circuit.

If the category specified by the received indication is not a loading image (“no” branch of the conditional block 506), but the category specified by the received indication is a title image (“yes” branch of the conditional block 510), then the client device reduces a level of motion-compensated frame interpolation (block 512). This reduction and other steps and decisions are used for rendering subsequent video frames until an indication specifying another category is received. The client device also reduces performance for graphics tasks (block 514). The client device provides lower priority levels to parallel data tasks executed by the parallel data processing circuit. The client device can also adjust the P-state of the parallel data processing circuit to reduce the performance of the parallel data processing circuit. If the category specified by the received indication is not a loading image (“no” branch of the conditional block 506), and the category specified by the received indication is not a title image (“yes” branch of the conditional block 510), then the client device generates indications specifying one or more of commands and operating parameters based on another category of the N categories (block 516).

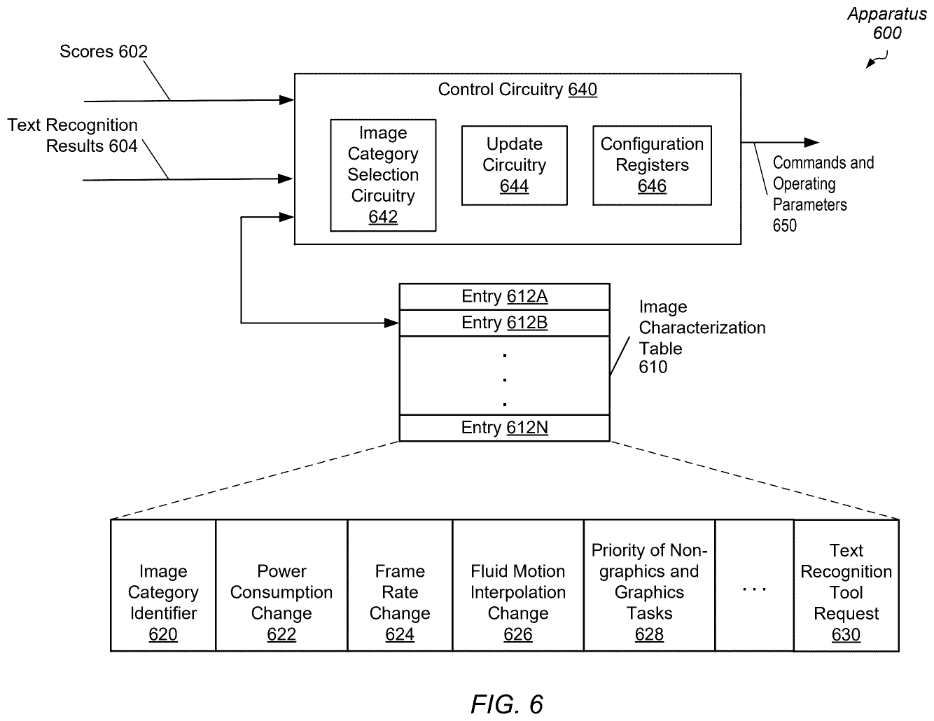

Turning now to FIG. 6, a generalized diagram is shown of an apparatus 600 that performs efficient video data processing. As shown, apparatus 600 includes image characterization table 610 (or table 610) and the control circuitry 640. Control circuitry 640 receives scores 602 and information from the table 610 and generates either updates of the table 610 or an indication specifying the commands and operating parameters 650. The control circuitry 640 includes image category selection circuitry 342, the update circuitry 644, and the configuration registers 646. Table 610 stores information in the entries 612A-612N. Each of these entries includes the fields 620-630. In various implementations, the functionality provided by apparatus 600 is also provided in one or more of processing circuit 202 and processing circuit 210 (of FIG. 2).

Table 610 is implemented with one of flip-flop circuits, one of a variety of types of a random-access memory (RAM), a content addressable memory (CAM), or other. Although particular information is shown as being stored in the fields 620-630, and in a particular contiguous order, in other implementations, a different order is used and a different number and type of information is stored. Table 610 includes information that characterizes the rendering and presentation of video frames. Field 620 stores a unique identifier (ID) of an image category. Each of the image categories (or categories) specifies a type of image corresponding to a rendered video frame to be presented on the screen of a display device.

The active gameplay image can include a variety of types of images such as a first person point of view of a flight game or a racing game or a sporting event game or a fantasy and adventure game, a third person point of view of a character in a game environment, a top view of a puzzle or a card game, and so forth. Examples of the categories are a menu image, an application loading image, a scoreboard image, and an active gameplay image. Other examples of the categories are a character or avatar selection image that presents a list of different characters from which to choose by the user, an inventory image that presents a list of objects for the character to carry or wear, a skill image that presents a skill level tree indicating a player's or character's strengths, and a map image that presents a top level view of a playing environment.

Field 622 stores an indication specifying a power consumption change based on the identifier stored in field 620. The indication can specify the power-performance states (P-states) or an amount of updates to the P-states of at least the I/O interfaces, the general-purpose processing circuit, and the parallel data processing circuit to modify one or more of the operating clock frequencies and operating power supply voltages of these components. Based on the identifier stored in field 620, the indication stored in field 624 specifies a frames per second (FPS) parameter or an amount of increase or reduction of the FPS parameter. Based on the identifier stored in field 620, the indication stored in field 626 specifies a fluid motion interpolation parameter or an amount of increase or reduction of the fluid motion interpolation parameter. This parameter specifies a level of motion-compensated frame interpolation.

Field 628 stores an indication specifying priority levels of non-graphics tasks and graphics tasks based on the identifier stored in field 620. Based on the identifier stored in field 620, the indication stored in field 630 specifies whether a request is sent to a text recognition tool to perform optical character recognition (OCR) of a rendered video frame. Another example of features with indications stored in fields of entries 612A-612N specifying a level or enablement of the features is a level of anti-aliasing that allows images to appear less blurred due to smoothing out of the edges of the images. Yet another example of the features is vertical synchronization, or vertical sync (or vsync), that is a graphics feature that synchronizes the frame rate of a video game with a refresh rate of a display device such as a monitor of a video gaming system. In other implementations, another number and types of features are adjusted (or enabled) by information stored in table 610.

In various implementations, control circuitry 640 receives scores 602 that include a score for each of the available categories. A parallel data processing circuit sends a rendered video frame to an image classification data model that generates scores 602. Circuitry 642 selects a category with a highest score of scores 602 and generates a corresponding index used to search table 610. Based on information stored in the hit entry of entries 612A-612N, circuitry 644 generates the commands and operating parameters 650 to send to other components of the client device. In some implementations, circuitry 644 compares the information from the hit entry with corresponding thresholds stored in the configuration registers 646. The values stored in the configuration registers 646 can be read from flip-flop circuits, one of a variety of types of a ROM, one of a variety of types of a random-access memory (RAM), a content addressable memory (CAM), or others. In various implementations, configuration registers 646 include programmable registers. In some implementations, circuitry 644 generates a weighted sum based on the comparisons and compares the weighted sum to a corresponding threshold. The comparisons are used to generate the commands and operating parameters 650.

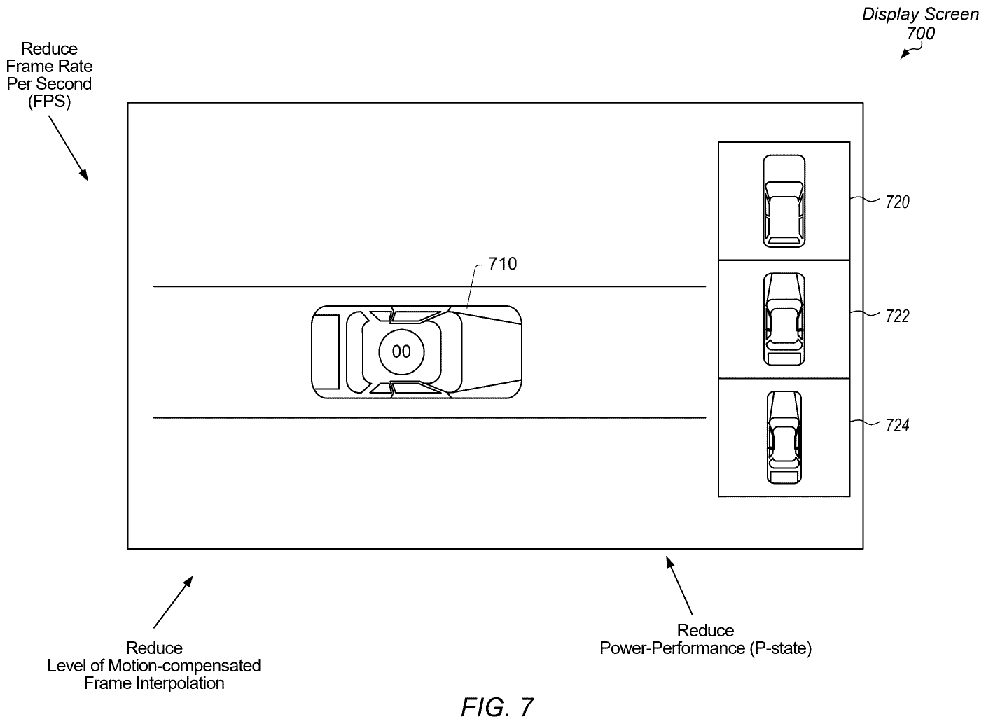

Turning now to FIG. 7, a generalized diagram is shown of a display screen 700 of a computing device that performs efficient video data processing. In various implementations, display screen 700 is an inventory image of a video game application presented on a display device of a user's computing device. Other components of the display device are not shown for ease of illustration. The inventory image provides an example of an image that corresponds to a rendered video frame of a parallel data graphics application such as a video game application. Display screen 700 includes objects for the user to select. In an implementation, the objects are vehicles to use in a video auto racing game application. When the user selects one of the objects 720-724, the selected object is shown in a larger form as object 710. It is possible that the object 710 rotates or is shown in a different view or angle.

The parallel data processing circuit of the client device sends commands, based on the category of the inventory image, to components of the client device to adjust one or more of the rendering and presenting operations for subsequent video frames. As shown by notations, for the inventory image, the parallel data processing circuit generates commands to reduce the FPS parameter, reduce the level of motion-compensated frame interpolation, and reduce the performance and power consumption of at least the parallel data processing circuit.

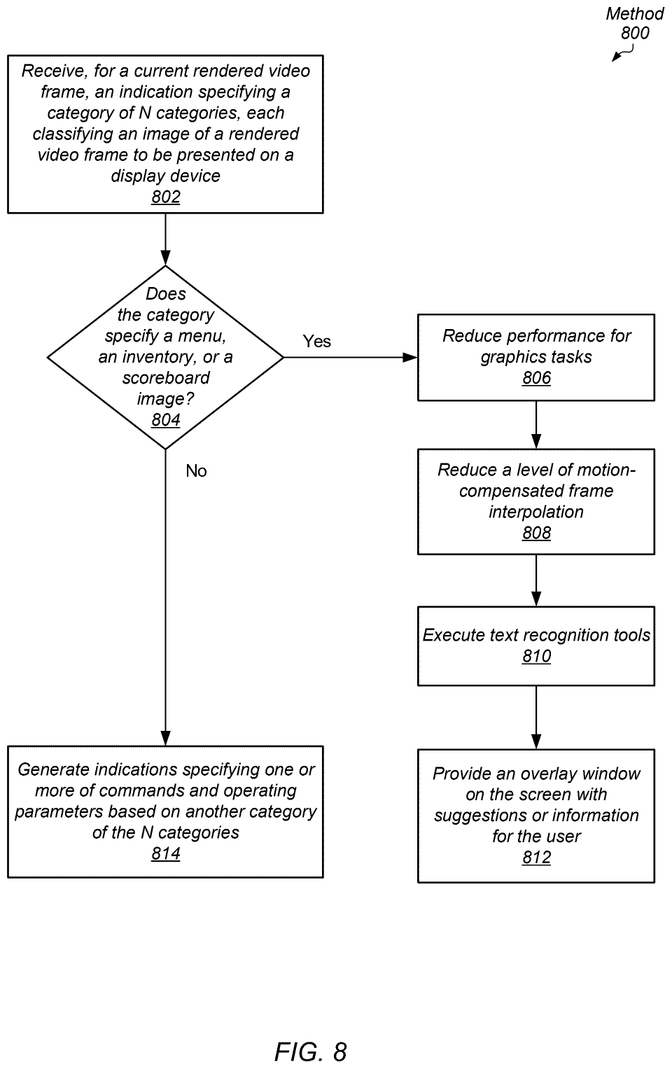

Referring now to FIG. 8, a generalized block diagram is shown of a method 800 for performing efficient video data processing. A parallel data processing circuit of a client device renders and presents video frames by executing a parallel data graphics application that processes multiple video frames. The parallel data processing circuit (or processing circuit) receives, for a current rendered video frame, an indication specifying a category of N categories, each classifying an image of a rendered video frame to be presented on a display device (block 802). Here, N is a positive, non-zero integer. Each of the categories specifies a type of image corresponding to a rendered video frame of the parallel data graphics application to be presented on a display device. In some implementations, the parallel data graphics application is a video game application. Examples of the categories are a menu image, an application loading image, a scoreboard image, and an active gameplay image. Other examples of the categories were provided earlier.

If the category specified by the received indication is a menu image, an inventory image, or a scoreboard image (“yes” branch of the conditional block 804), then the client device reduces performance for graphics tasks (block 806). This reduction and other steps and decisions are used for rendering subsequent video frames until an indication specifying another category is received. The client device provides lower priority levels to parallel data tasks executed by the parallel data processing circuit. The client device can also adjust the P-state of the parallel data processing circuit to reduce the performance of the parallel data processing circuit. The client device also reduces the level of motion-compensated frame interpolation (block 808). This reduction reduces graphics artifacts that can be seen on the screen of the display device. Each of the menu image, the inventory image, or the scoreboard image lacks motion, so the level of motion-compensated frame interpolation is not required to be high.

The client device executes text recognition tools (block 810). In some implementations, the client device sends the rendered video frame to another data model that performs text recognition such as optical character recognition (OCR). The text recognition tool identifies options, items, characteristics, lists and so forth presented on the image corresponding to the rendered video frame. Based on result data from the text recognition tool, the client device provides an overlay window on the screen with suggestions or information for the user (block 812).

In some implementations, the client device accesses one or more of configuration files, databases and so on to obtain popular choices by other users for the recognized options, items, characteristics, and lists. In another implementation, the client device accesses one or more of the configuration files, the databases and so on to obtain recommendations for the recognized options, items, characteristics, and lists that have provided high scores in the game presented by the parallel data graphics application. The client device presents the popular choices or recommendations in the overlay window on the screen. If the category specified by the received indication is not one of the menu image, the inventory image, and the scoreboard image (“no” branch of the conditional block 804), then the client device generates indications specifying one or more of commands and operating parameters based on another category of the N categories (block 814). Examples of these indications and other categories were provided earlier.

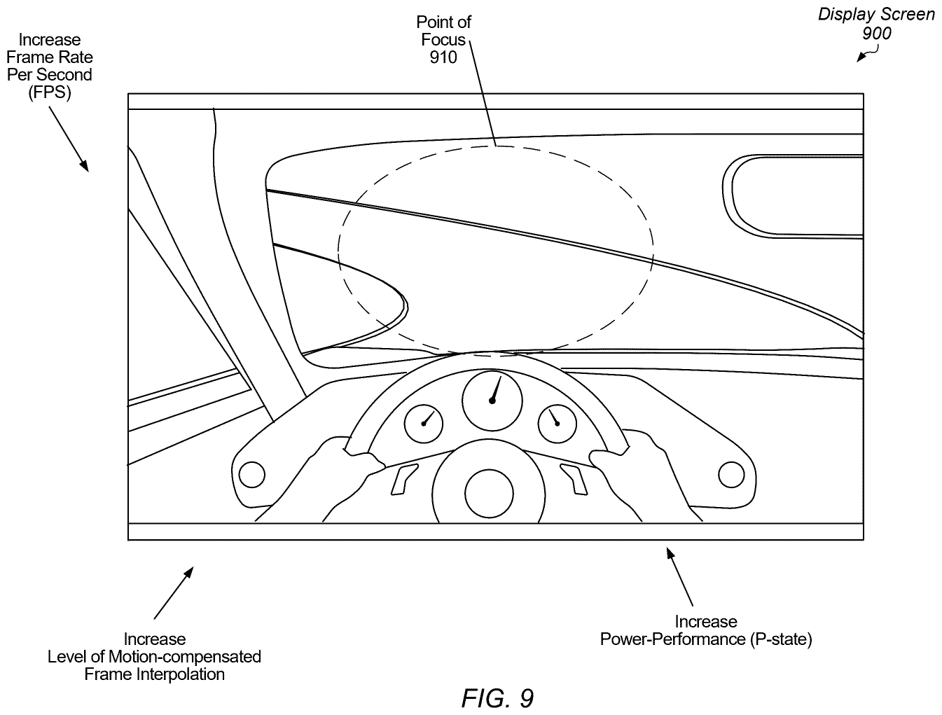

Turning now to FIG. 9, a generalized diagram is shown of a display screen 900 of a computing device that performs efficient video data processing. In various implementations, display screen 900 is an active gameplaying image of a video game application presented on a display device of a user's computing device. Other components of the display device are not shown for ease of illustration. The active gameplaying image provides an example of an image that corresponds to a rendered video frame of a parallel data graphics application such as a video game application. Display screen 900 includes one of a first person point of view, a third person point of view, or multiple points of view with multiple split screens or windows within windows on the screen. As shown, the user is playing an auto racing video game with a first person point of view.

The primary point of focus 910 is the road ahead through the windshield shown on the screen of the display device the client device. In some implementations, the primary point of focus is the user's object (e.g., a racecar, a soldier, a football player) in the video game. A secondary point of focus is one of an opposing player's object, the scrollbar displaying statistical data at the bottom of the screen, and so on. The parallel data processing circuit of the client device sends commands, based on the category of the active gameplaying image, to components of the client device to adjust one or more of the rendering and presenting operations for subsequent video frames. As shown by notations, for the active gameplaying image, the parallel data processing circuit generates commands to increase the FPS parameter, increase the level of motion-compensated frame interpolation, and increase the performance and power consumption of at least the parallel data processing circuit. For the primary point of focus 910, in an implementation, the parallel data processing circuit sends a command to increase the level of rendering and select lower levels of rendering for subregions of display screen 900 located farther away from point of focus 910 such as along the edges of display screen 900.

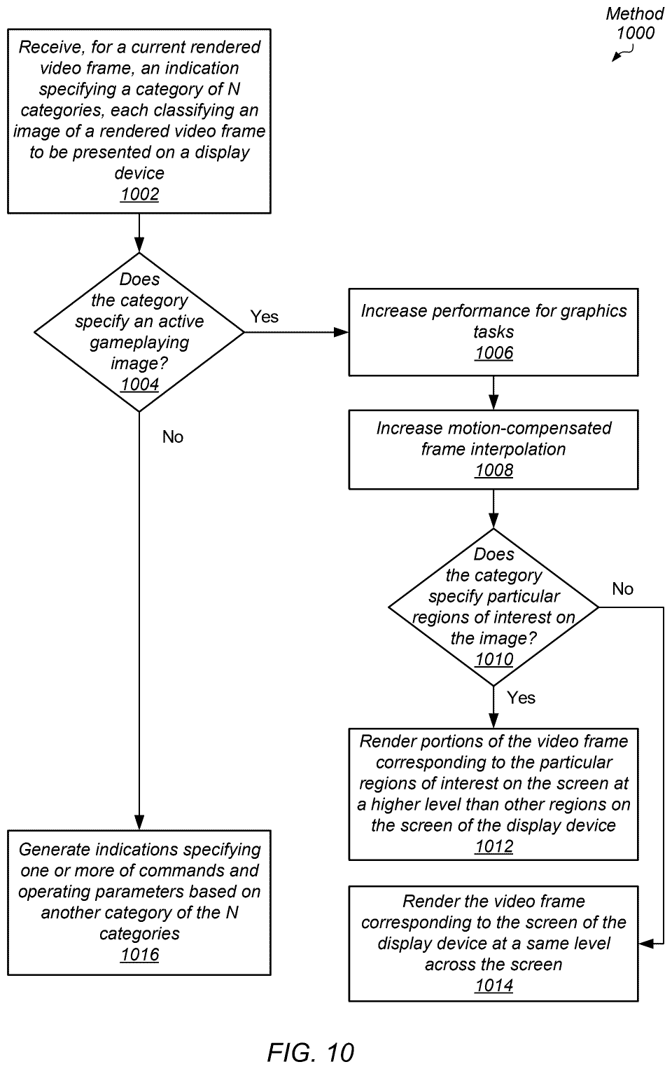

Referring now to FIG. 10, a generalized block diagram is shown of a method 1000 for performing efficient video data processing. A parallel data processing circuit (or processing circuit) of a client device receives, for a current rendered video frame, an indication specifying a category of N categories, each classifying an image of a rendered video frame to be presented on a display device (block 1002). Here, N is a positive, non-zero integer. In some implementations, the application is a video game application. Examples of the categories are a menu image, an application loading image, a scoreboard image, and an active gameplay image. Other examples of the categories were provided earlier.

If the category specified by the received indication is an active gameplaying image (“yes” branch of the conditional block 1004), then the client device increases performance for graphics tasks (block 1006). This reduction and other steps and decisions are used for rendering subsequent video frames until an indication specifying another category is received. The client device provides higher priority levels to parallel data tasks executed by the parallel data processing circuit. The client device can also adjust the P-state of the parallel data processing circuit to increase the performance of the parallel data processing circuit. The client device also increases the level of motion-compensated frame interpolation (block 1008). This reduction reduces graphics artifacts that can be seen on the screen of the display device. The active gameplaying image can include a relatively high amount of motion, so the level of motion-compensated frame interpolation can be required to be high.

If the category does not specify particular regions of interest on the image (“no” branch of the conditional block 1010), then the client device renders the video frame corresponding to the screen of the display device at a same level across the screen (block 1014). Otherwise, if the category specifies particular regions of interest on the image (“yes” branch of the conditional block 1010), then the client device renders portions of the video frame corresponding to the particular regions of interest on the screen at a higher level than other regions on the screen of the display device (block 1012). In an implementation, the application is a video auto racing game, and identifiers specifying regions of interest corresponding to the where the user's eyes highly likely view the screen are used by the parallel data processing circuit to use higher levels of rendering of the video frame data. Other regions corresponding to the where the user's eyes are less likely to view the screen are used by the parallel data processing circuit to use lower levels of rendering of the video frame data. If the category specified by the received indication is not one of the menu image, the inventory image, and the scoreboard image (“no” branch of the conditional block 1004), then the client device generates indications specifying one or more of commands and operating parameters based on another category of the N categories (block 1016).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
perform rendering operations on a plurality of video frames using a first set of parameters;
send a first video frame of the plurality of video frames to a display device; and
perform a rendering operation on a second video frame of the plurality of video frames using a second set of parameters different from the first set of parameters, responsive to an indication generated by a machine learning model specifying a first category of a plurality of categories.

2. The apparatus as recited in claim 1, wherein the plurality of categories comprise one or more of a menu image, an application loading image, a scoreboard image, and an active gameplay image.

3. The apparatus as recited in claim 2, wherein one or more of the first set of parameters and the second set of parameters comprises identifiers specifying one or more subdivisions of a third video frame of the plurality of video frames to process differently from other subdivisions of the third video frame.

4. The apparatus as recited in claim 2, wherein the first set of parameters comprises a first level of motion-compensated frame interpolation set by a user and the second set of parameters comprises a second level of motion-compensated frame interpolation different from the first level of motion-compensated frame interpolation.

5. The apparatus as recited in claim 2, wherein based on the first category, the circuitry is further configured to generate an overlay to send to a display controller with the second video frame, wherein the overlay comprises suggestions to present to a user.

6. The apparatus as recited in claim 2, wherein based on the first category, the circuitry is further configured to send the first video frame to an optical character recognition data model.

7. The apparatus as recited in claim 6, wherein in response to receiving result data from the optical character recognition data model, the circuitry is further configured to generate an overlay to send to a display controller with the second video frame, wherein the overlay comprises suggestions to present to a user.

8. A method, comprising:
performing, by a processing circuit, a rendering operation on a plurality of video frames using a first set of parameters;
sending, by the processing circuit, a first video frame of the plurality of video frames to a display device; and
performing, by the processing circuit, a rendering operation on a second video frame of the plurality of video frames using a second set of parameters different from the first set of parameters, responsive to an indication generated by a machine learning model specifying a first category of a plurality of categories.

9. The method as recited in claim 8, wherein the plurality of categories comprises one or more of a menu image, an application loading image, a scoreboard image, and an active gameplay image.

10. The method as recited in claim 9, wherein one or more of the first set of parameters and the second set of parameters comprises identifiers specifying one or more subdivisions of a third video frame of the plurality of video frames to process differently from other subdivisions of the third video frame.

11. The method as recited in claim 9, wherein the first set of parameters comprises a first level of motion-compensated frame interpolation set by a user and the second set of parameters comprises a second level of motion-compensated frame interpolation different from the first level of motion-compensated frame interpolation.

12. The method as recited in claim 9, wherein based on the first category, the method further comprises generating, by the processing circuit, an overlay to send to a display controller with the second video frame, wherein the overlay comprises suggestions to present to a user.

13. The method as recited in claim 9, wherein based on the first category, the method further comprises sending, by the processing circuit, the first video frame to an optical character recognition data model.

14. The method as recited in claim 13, wherein in response to receiving result data from the optical character recognition data model, the method further comprises generating, by the processing circuit, an overlay to send to a display controller with the second video frame, wherein the overlay comprises suggestions to present to a user.

15. A computing system comprising:
circuitry configured to execute a machine learning model; and
a processing circuit configured to:
perform rendering operations on a plurality of video frames using a first set of parameters;
send a first video frame of the plurality of video frames to a display device; and
perform a rendering operation on a second video frame of the plurality of video frames using a second set of parameters different from the first set of parameters, responsive to an indication generated by the machine learning model specifying a first category of a plurality of categories.

16. The computing system as recited in claim 15, wherein the plurality of categories comprises one or more of a menu image, an application loading image, a scoreboard image, and an active gameplay image.

17. The computing system as recited in claim 16, wherein one or more of the first set of parameters and the second set of parameters comprises identifiers specifying one or more subdivisions of a third video frame of the plurality of video frames to process differently from other subdivisions of the third video frame.

18. The computing system as recited in claim 16, wherein the first set of parameters comprises a first level of motion-compensated frame interpolation set by a user and the second set of parameters comprises a second level of motion-compensated frame interpolation different from the first level of motion-compensated frame interpolation.

19. The computing system as recited in claim 16, wherein based on the first category, the circuitry is further configured to generate an overlay to send to a display controller with the second video frame, wherein the overlay comprises suggestions to present to a user.

20. The computing system as recited in claim 16, wherein based on the first category, the circuitry is further configured to: send the first video frame to an optical character recognition data model.
